(19) United States
(12) Patent Application Publication
(10) Pub. No.: US 2009/0077466 A1
(43) Pub. Date: Mar. 19, 2009

(54) Network based application for performing coaching services

(75) Inventors: Margaret Altmix, Des Moines, IA (US); Paul Hedquist, Des Molnes, IA (US); Robert Gray, Des Moines, IA (US)

Correspondence Address: BRIGGS AND MORGAN P.A., 2200 IDS CENTER, 80 SOUTH 8TH ST, MINNEAPOLIS, MN, 55402, US

(73) Assignee: Employee & Family Resources, Des Moines, IA (US)

(21) Appl. No.: 11/900,837

(22) Filed: Sep. 13, 2007

(51) Int. Cl. G06F 3/00

(52) U.S. Cl. 715/709

(57) ABSTRACT

A computer information network based application for communication between individuals is provided. The application comprising a dashboard for graphically depicting a plurality of windows adapted for the exchange of information between the individuals.

### FIELD OF THE INVENTION

This invention relates to a computer implemented method of coaching individuals in matters of interest and concern. In particular, the invention relates to an application accessible over a computer network for providing coaching and counseling in the field of retirement planning services.

### BACKGROUND OF THE INVENTION

A wide variety of goods are now provided over computer networks, and in particular over global computer information networks such as the World Wide Web a/k/a the Internet. Examples of such goods are legion, including, books, music, clothing, movies, computers, consumer electronics, games, toys, furniture, automotive goods, tools, and the like. Many well known and even famous companies provide such goods either exclusively over the Internet or in conjunction with traditional brick and mortar storefront operations.

Consumers and merchants find this method of commerce advantageous for a variety of reasons. First, the Internet provides convenience in that consumers do not have to travel to a storefront to make a purchase. They can simply select the items they want, purchase them with a credit card, and receive the items by home delivery. Second, Internet shopping provides a very convenient method to compare and contrast items. Often, commercial websites provide large inventory that consumers can review on-line, or consumers can browse between competitive sites to compare and contrast items. Third, the Internet provides freedom from sales personal that some consumers may prefer to not interact with personally. For example, Internet shopping for many allows them to avoid the pressure of over aggressive salespersons. The impersonal nature of the Internet actually becomes an advantage in certain instances.

The situation with providing services over the Internet is much different. Traditionally, many services are provided on an in-person basis, which makes it very difficult or impossible to provide services over a computer network, or the Internet. Many service providers maintain websites for use by customers and clients; however, generally the websites provide nothing but information about the services, but not the actual services themselves. Or, by contrast, the Internet can be an excellent medium for providing computer related services such as access to Internet based software applications. In these cases, the service is application access, rather than in-person services, and as such the medium of delivery is not an essential or important ingredient to the services themselves. These types of services are well adapted for delivery via a computer information network.

This is not the case with highly personalized services commonly associated with in-person individual services that rely mainly on the interpersonal interaction between the client and the service provider. In the case of such services as counseling, personal or professional coaching, it is often the case that it is extremely difficult or impossible to provide services without personal interaction.

The basis of the services is inextricably bound up in the relationship between the service provider and the client. Heretofore, the lack of direct personal contact has been a substantial obstacle to providing personal service over the Internet. Thus, what is an advantage in the arena of goods becomes a disadvantage in the context of the delivery of personal services over a computer information network.

Accordingly, a need exists for a method for delivery of traditionally interpersonal services over a computer information network, and the solutions are not obvious or predictable.

### SUMMARY OF THE INVENTION

An object of the present invention is to provide an improved method of providing services through a computer information network.

These and other objects of the present invention will become apparent to those skilled in the art upon reference to the following specification, drawings, and claims.

The present invention intends to overcome the difficulties encountered heretofore. To that end a computer information network based application for communication between individuals is provided. The application comprising a dashboard for graphically depicting a plurality of windows adapted for the exchange of information between the individuals.

### BRIEF DESCRIPTION OF DRAWINGS

FIG. 1 is a screen shot of a Dashboard of the present invention.

FIG. 2 is a screen shot of a My Messages window of the Dashboard of the present invention.

FIG. 3 is a screen shot of a My Messages window of the Dashboard of the present invention.

FIG. 4 is a screen shot of a My Schedule window of the Dashboard of the present invention.

FIG. 5 is a screen shot of a My Goals window of the Dashboard of the present invention.

FIG. 6 is a screen shot of a My Library window of the Dashboard of the present invention.

FIG. 7 is a screen shot of a My Library window of the Dashboard of the present invention.

FIG. 8 is a screen shot of an article review screen of the My Library window of the Dashboard of the present invention.

FIG. 9 is a screen shot of an article review screen of the My Library window of the Dashboard of the present invention.

FIG. 10 is a screen shot of a My Journal window of the Dashboard of the present invention.

FIG. 11 is a screen shot of a My Journal window of the Dashboard of the present invention.

FIG. 12 is a screen shot of a Coach's Profile window of the Dashboard of the present invention.

### DETAILED DESCRIPTION OF THE PREFERRED EMBODIMENTS

In the Figures, a computer implementation of a network based application is shown. It is within the ordinary skill of the art to select a suitable and conventional computer language for coding the present invention, as well as implement the invention in a multiple user computer network environment. In the preferred embodiment of the invention the application is an implementation of a computer based coaching application, and in the most preferred embodiment the coaching application is for retirement planning coaching. Those of ordinary skill in the art will understand that the invention in not necessarily so limited.

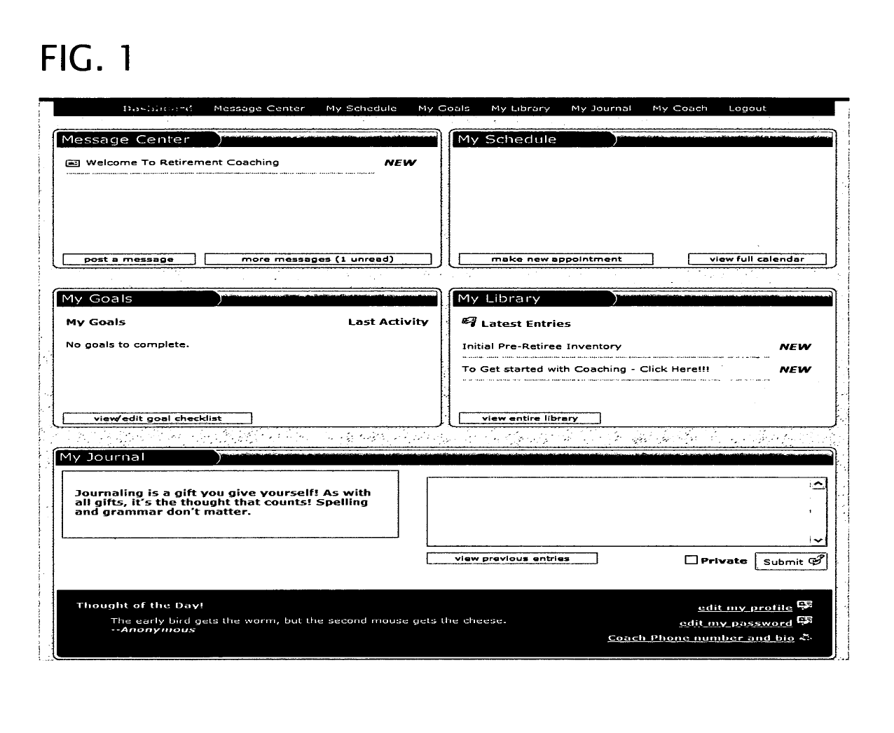

FIG. 1 shows a screen shot of an application home page, commonly referred to as a Dashboard. The Dashboard includes a number of application panes or windows from which a user can select in order to practice various aspects of the invention. The application windows, and the text appearing in and thereabout, are generally hypertext links which the user can select with a conventional computer mouse to allow for navigation to the other screens described and depicted herein.

In addition to the foregoing scheme of navigation, an additional means is provided. At the top of the Dashboard text based hyper links appear that a user can select to navigate to the screen of the users' choice. These text links appear as headings in most if not all of the screens of the application to allow for backward navigation. The same navigation options provided by the text based links are available from the Dashboard by selecting the application pane. This scheme is generally applicable throughout the application.

Returning to FIG. 1, it shows five navigation panes or windows, including, Message Center, My Schedule, My Goals, My Library, and My Journal. An additional heading, My Coach, appears at the top of the Dashboard as a text link, but does not have an associated navigation pane in the Dashboard.

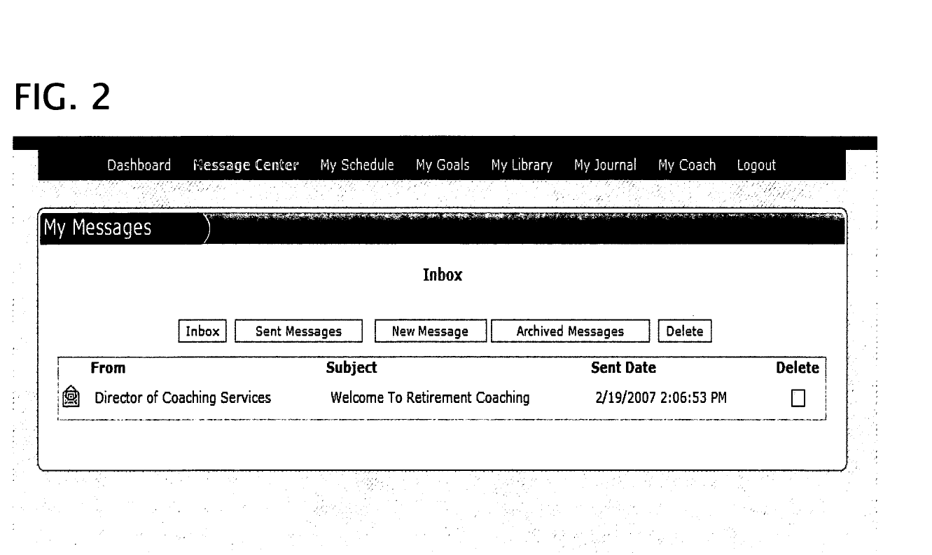

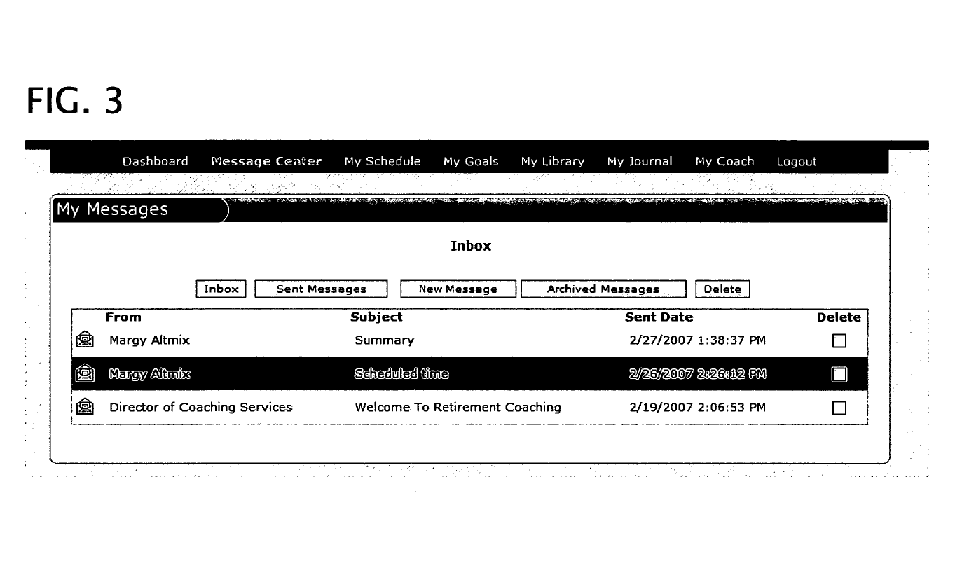

Selecting the My Messages navigation window from the Dashboard, or text heading from any window in which it appears, launches the My Messages navigation window shown in FIGS. 2 and 3. In this window messages of relevance to the user can be posted for review by the user. The messages can by posted by the users' coach, by a system administrator, or the like. The messages are hypertext active and can be opened by selecting them with the computer mouse click. Once open the message can be read, viewed, deleted, responded to, and the like.

The My Messages window displays various information about the messages, such as who the message is from, the subject of the message, and the date sent. A check box is provided to the far right of each message which when selected will delete the message.

The My Messages window also includes a plurality of tabs. FIGS. 2, 3 show the Inbox tab, which displays the users' new messages. The user can select the Sent Messages tab to view messages sent by the user to other users, or to the users' coach. There is an Archived Messages tab to view archived or saved messages. Also, the My Messages window includes a Delete tab which allows the user to manage removal of messages.

The My Messages navigation window is a useful tool in managing communication between the users and their coaches. The window allows for two way communication on topics of interest, such as status of progress on goals, scheduling new coaching sessions, and sharing useful information on any subject of interest or value to the users and coaches.

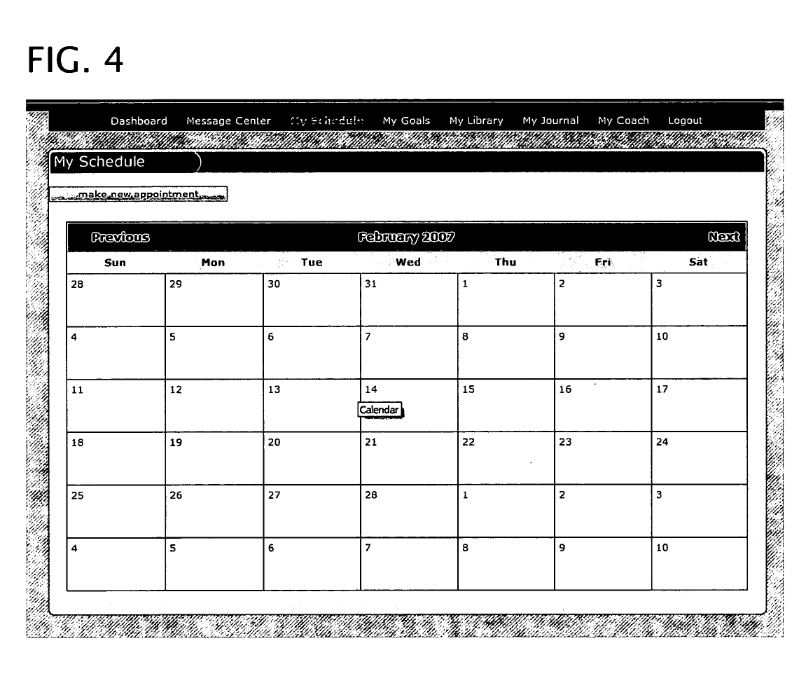

Selecting the My Schedule navigation window from the Dashboard, or text heading from any window in which it appears, launches the My Schedule navigation window shown in FIG. 4. In this window, the users and their coaches can schedule, track, and amend appointments and other events of interest. The window displays a current month calendar which will show an appointment under the applicable day of the month along with a brief description entered by the person who scheduled the appointment.

Appointments can be entered by selecting the Make New Appointment tab appearing in above the calendar. The users can also schedule reminders and other calendar based events through the appointment screen.

The My Schedule window defaults to display the current calendar month; however, users can change the display by selecting the Previous and Next text links on either side of the top of the calendar.

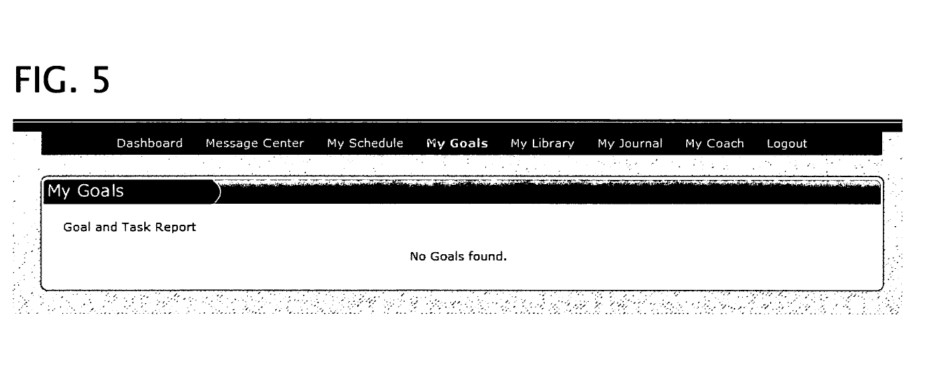

Selecting the My Goals navigation window from the Dashboard, or text heading from any window in which it appears, launches the My Messages navigation window shown in FIG. 5. In this window, the users can review, set, and otherwise appraise goals that have been set for users by, or through, their coach. As a result of specific discussion in relation to topics of concern for users, coaches may assign goals or tasks that users can accomplish or focus on during the coaching process. The My Goals navigation window is used to facilitate this aspect of the coaching process.

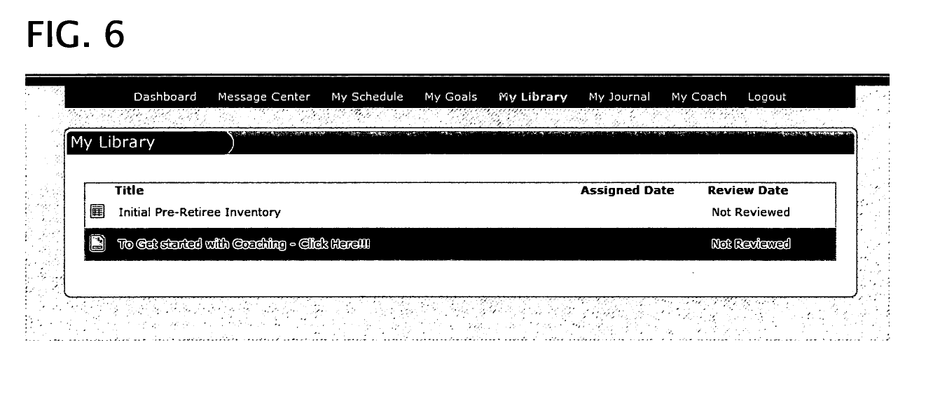

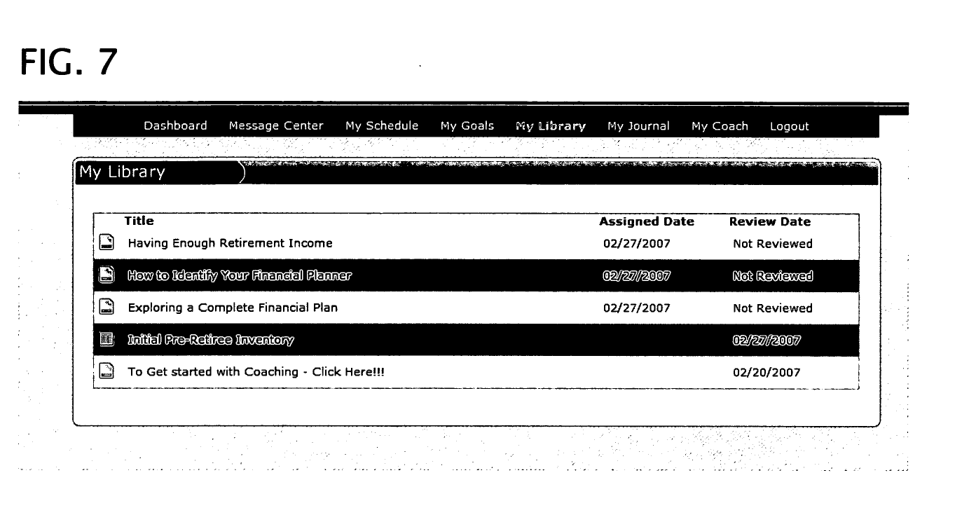

Selecting the My Library navigation window from the Dashboard, or text heading from any window in which it appears, launches the My Library navigation window shown in FIGS. 6 or 7. In this window, coaches can assign to users articles or publications on topics of interest that might be helpful in furthering the coaching process. The My Library navigation window lists certain attributes for each article, including, the title, the date the article was assigned, and the review status. The review status lets the coaches and users know if they article has been reviewed, and if so on what date. Once the article has been viewed, the assigned date is removed and the review date is assigned.

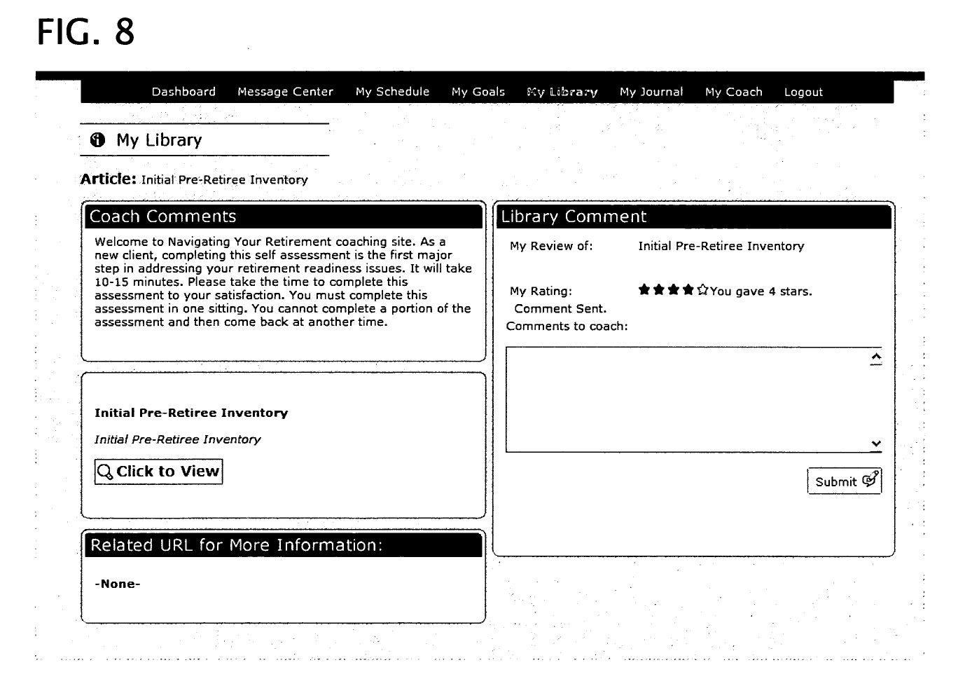

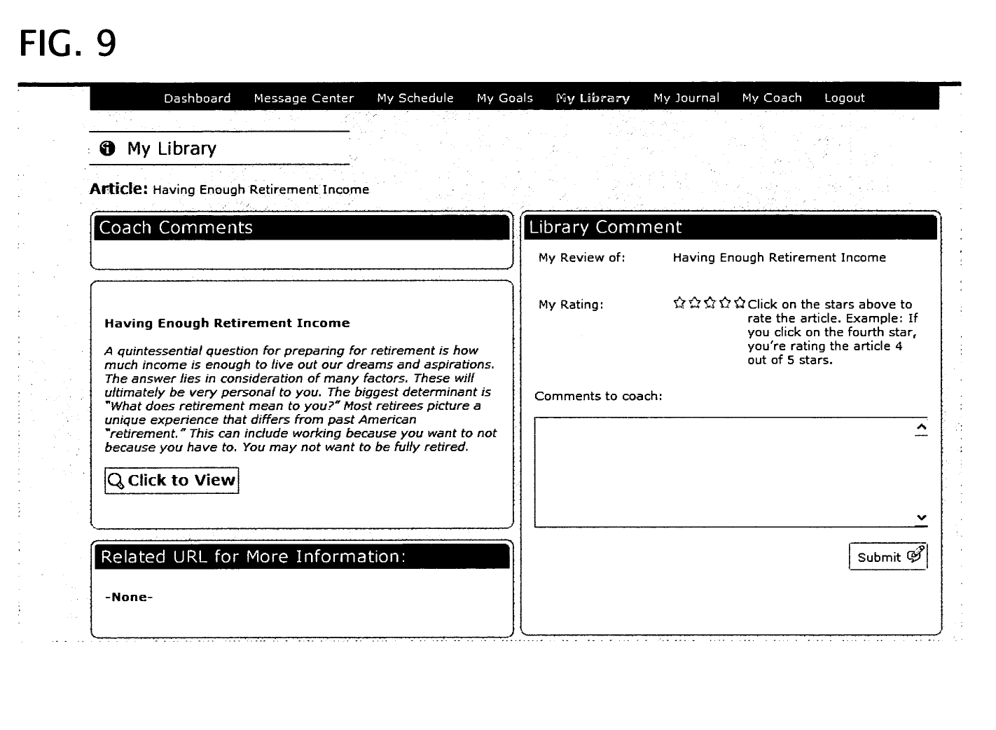

Any specific article can be reviewed or downloaded by selecting the article with the mouse to activate the hypertext link associated with the article. FIGS. 8, 9 shows in details the contents of the My Library reference review screen. The screen displayed in FIG. 8 appears after selecting the “Initial Pre-Retiree Inventory” article shown in FIG. 7.

The article review screen includes four navigation windows associated with the selected article. The first window allows coaches to enter comments describing the article to users, or provide any other useful or relevant information. Below the comment window is a window that includes a link to actually view/download the article. Below the view article window is a window that can display any related information that may be associated with the article in the form of a URL hypertext link to the information. Finally, to the right of the three previously described windows is a comment window. The comment window allows the user to rate the article and enter any comments or thoughts about the article. These are viewable by coaches and may prove helpful in evaluating the applicability of the article or determining whether the article addressed the intended issue or topic.

FIG. 9 is similar, except that it is displayed after selecting the “Having Enough Retirement Income” article shown in FIG. 7.

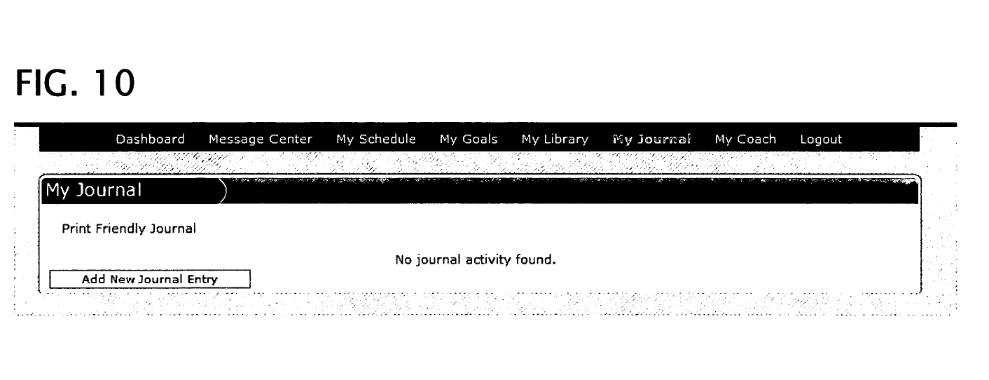

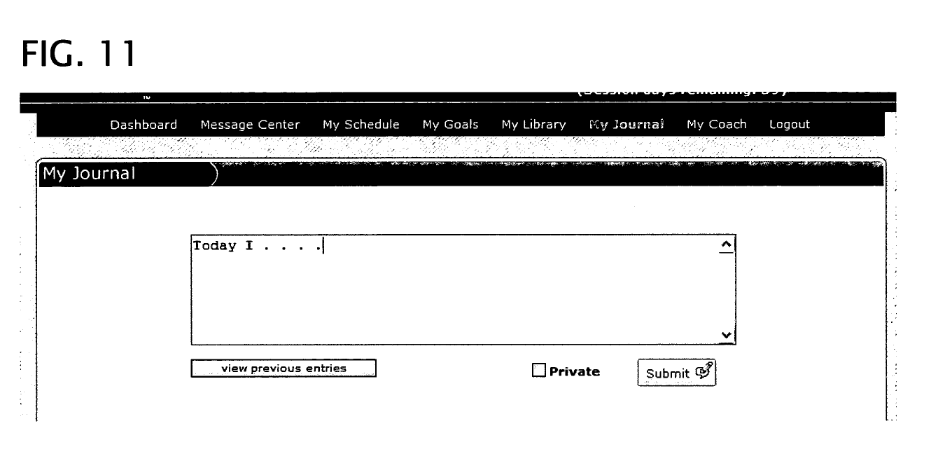

Selecting the My Journal navigation window from the Dashboard, or text heading from any window in which it appears, launches the My Journal navigation window shown in FIGS. 10 and 11. In this window, users can keep a personal journal of topics of interest including those relating to the coaching experience. Users can initiate a journal entry by selecting the Add New Journal Entry button, which will open the window shown in FIG. 11. Users can then enter a particular entry. Journal entries are generally viewable by coaches; however, users can mark entries as private by selecting the Private check box, which would prevent others from viewing the entry.

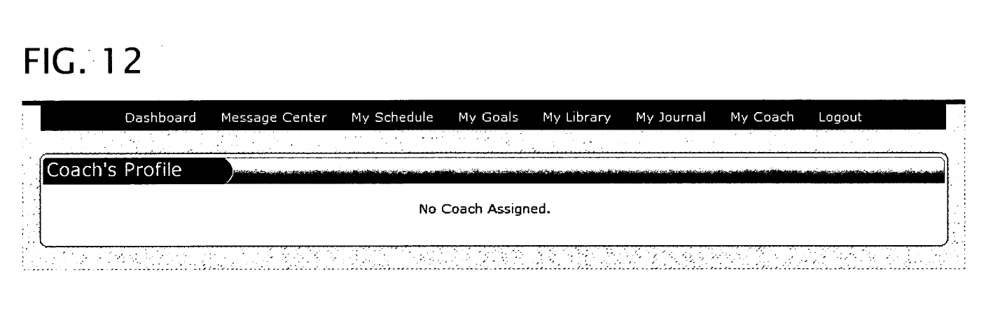

Selecting the My Coach text heading from any window in which it launches the My Coach window shown in FIG. 12. FIG. 12 shows that no coach has been assigned to the particular user; however, when a coach is assigned the window would show the coaches resume and contact information.

Returning to FIG. 1, each of the navigation windows depicted in FIG. 1 include hypertext linked navigation shortcuts that allow users to initiate some of the functionality of the individual windows without launching the full associated navigation window. For example, the Message Center window shown on the Dashboard allows users to directly post messages by selecting the Post Message icon, or view messages by selecting the More Messages icon. The My Scheduling window shown on the Dashboard allows users to quickly make a new appointment by selecting the Make New Appointment icon. The My Goals window shown on the Dashboard allows users to view and edit goals by selecting the View/Edit Goal Checklist icon. The My Library window shown on the Dashboard allows users to view the contents of the library by selecting the View Entire Library icon. Also, the My Journal window on the Dashboard includes functionality to allow users to directly make a journal entry without entering the window shown in FIGS. 10, and 11.

Users and coaches can use the application to conduct personal coaching interactions, where the users and coaches can schedule coaching sessions through the My Schedule window. The coaching sessions can be conducted in person, over the phone, or in any other convenient manners. The users and coaches can deliver messages to each other via the Message Center to track the status of coaching, to communicate changes in scheduled events, or for any other coaching related purpose. Further, users and coaches can set coaching related goals and track progress against those goals through the My Goals window. Similarly, coaches can post articles helpful to users in accomplishing their goals, or of general interest to users through the My Library window. Finally, the My Journal window allows users to enter in a diary fashion comments, thoughts, and ideas related to coaching that may or may not be viewable by coaches.

A further embodiment of the invention relevant to the retirement coaching application of the invention comprises the use of an assessment criterion in association with the computer implementation of the coaching application. An assessment (see Appendix), is designed to assess eight key, or essential, elements as they relate to retirement and/or quality or life issues for people approaching retirement age, regardless of the person's exact plans. In other words, the assessment and coaching process is in the most preferred embodiment designed to assist in retirement planning; however, it is not necessarily so limited.

The assessment and coaching process is helpful for all types of mid-life transitions, such as partial retirement, career change, goal setting, and other related transitional aspects of life.

The assessment is particularly helpful in evaluating the following criteria:

Moving the Benefits of Work into Retirement—Work provides people with much more than a paycheck. It brings a sense of order and predictability to people's lives, and provides time management structure to 40 or more hours each week. Work gives people purpose, meaning and identity, and is a primary source of socialization opportunities. Successful retirees find a way to replace all these benefits.

Increasing Resilience—Arguably, more life changes occur in retirement than in any other stage of life, impacting one's physical, emotional, financial and relational well-being. Resilient people are better able to adapt to change and to recover quickly from setbacks.

Meeting Social Needs—A person's social network is a greater predictor of retirement satisfaction than wealth or health. Indeed, studies show that retirees who regularly interact with others are healthier, happier and live longer lives. Developing and maintaining one's social network, therefore, is a critical challenge for retirees.

Enriching Family Life—Retirement impacts every member of the family, including life partner, adult children, parents, even grandchildren. Retirement can be an enriching time in which to attend to those relationships for which one may not have had time while working full time, and to heal old wounds, if needed.

Achieving Life Meaning—Defining and committing to attain one's individual goals, dreams, or life mission adds to one's personal fulfillment. Finding one's unique path and purpose is critical to the retiree's sense of peace and contentment.

Enjoying Leisure—Retirement is about living a leisurely life, not a life of leisure. A key to success is discovering activities that renew us, and participating in them in ways that rejuvenate us.

Optimizing Health and Wellness—Retirement can be the longest of life's stages, necessitating taking care of one's overall health through practices that enhance physical, mental and emotional wellness.

Financial Security.

The assessment checklist can be assigned to users through the My Library navigation window located in the Dashboard. The user's coach can post the assessment checklist in the My Library window for the user to fill out. After filling out the checklist, each of the foregoing elements are evaluated to determine the relative importance of the element to the user, and the user's level of confidence or concern over that element. This evaluation is done through a scoring process using the values entered on the assessment checklist.

After the assessment is complete, it can be used as a guide for the coaching process by defining the issues of importance and ranking them in relative order of importance. The coach and the user can then determine the best path or process for resolving any issues or concerns.

In this manner, the application provides an extremely helpful and easily accessible tool for conducting, documenting, and realizing the coaching experience in a manner that relies less on traditional personal interaction than prior art coaching methods and techniques. In this manner, the present invention substantially eliminates the problems of the prior art.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A computer information network based application for communication between individuals, said application comprising:
a dashboard for graphically depicting a plurality of windows adapted for the exchange of information between said individuals.

2. The application according to claim 1 wherein said windows comprise a message center window that is adapted to allow at least one of said individuals to post messages to at least one other of said individuals.

3. The application according to claim 1 wherein said windows comprise a schedule window that is adapted to allow at least one of said individuals to schedule appointments with at least one other of said individuals.

4. The application according to claim 1 wherein said windows comprise a goals window that is adapted to allow at least one of said individuals to set goals for at least one other of said individuals.

5. The application according to claim 1 wherein said windows comprise a library window that is adapted to allow at least one of said individuals to post information for at least one other of said individuals to review.

6. The application according to claim 1 wherein said windows comprise a journal window that is adapted to allow at least one of said individuals to make journal entries.

7. The application according to claim 1 wherein said windows comprise:
a message center window that is adapted to allow at least one of said individuals to post messages to at least one other of said individuals;
a schedule window that is adapted to allow at least one of said individuals to schedule appointments with at least one other of said individuals;
a goals window that is adapted to allow at least one of said individuals to set goals for at least one other of said individuals;
a library window that is adapted to allow at least one of said individuals to post information for at least one other of said individuals to review; and
a journal window that is adapted to allow at least one of said individuals to make journal entries.

8. The application according to claim 1 wherein said individuals comprise at least a coach and a target of said coach.

9. The application according to claim 8 wherein said plurality of windows are used by said coach and said target to conduct a personal coaching interaction.

10. The application according to claim 9 further comprising an assessment checklist adapted for obtaining information to identify objectives of said personal coaching interaction.

11. The application according to claim 10 wherein said assessment is adapted to obtain information about said targets perception of the benefits of work, resilience, social network, family life, personal fulfillment, leisure activities, health and wellness, and financial security.

12. The application according to claim 1 wherein said information exchanged relates to at least one of said individuals' retirement.

13. A computer information network based application for communication between individuals, said application comprising:
a dashboard for graphically depicting a plurality of windows adapted for the exchange of information between said individuals comprising at least a coach and a target of said coach and said windows are used by said coach and said target to conduct personal coaching interaction about at least on of said individual's retirement,
wherein said windows comprise:
a message center window that is adapted to allow at least one of said individuals to post messages to at least one other of said individuals;
a schedule window that is adapted to allow at least one of said individuals to schedule appointments with at least one other of said individuals;
a goals window that is adapted to allow at least one of said individuals to set goals for at least one other of said individuals;
a library window that is adapted to allow at least one of said individuals to post information for at least one other of said individuals to review; and
a journal window that is adapted to allow at least one of said individuals to make journal entries; and
an assessment checklist adapted for obtaining information to identify objectives of said personal coaching interaction, wherein said assessment is adapted to obtain information said targets perception of the benefits of work, resilience, social network, family life, personal fulfillment, leisure activities, health and wellness, and financial security.
